(19) United States
(12) Patent Application Publication
(10) Pub. No.: US 2018/0277039 A1
(43) Pub. Date: Sep. 27, 2018

(54) DISPLAY DEVICE AND DRIVING METHOD THEREOF

(71) Applicants: BOE TECHNOLOGY GROUP CO., LTD., Beijing (CN); BEIJING BOE DISPLAY TECHNOLOGY CO., LTD., Beijing (CN)

(72) Inventor: Chunbing ZHANG, Beijing (CN)

(21) Appl. No.: 15/544,902

(22) PCT Filed: Feb. 23, 2017
(86) PCT No.: PCT/CN2017/074552

§ 371 Date: Jul. 20, 2017

(30) Foreign Application Priority Data
May 30, 2016 (CN) 201610371628.1

(51) Int. Cl. G09G 3/3258

(52) U.S. Cl. CPC G09G 3/3258; G09G 2310/08; G09G 2330/021; G09G 2300/0465; G09G 2300/0814

(57) ABSTRACT

A display device and a driving method thereof are disclosed. The display device includes a timing controller, a switching unit, a voltage controller and a plurality of pixel units arranged sequentially, the timing controller is connected with the switching unit, the voltage controller is connected with the switching unit, and the switching unit is connected with the pixel units; the timing controller is configured to output a timing control signal for determining whether the switching unit electrically connects the voltage controller with the pixel units; the switching unit is configured to electrically connect the voltage controller with the pixel units in accordance with the timing control signal; each of the pixel units is configured to display when receiving the control voltage, wherein one of the switching unit can electrically connect the plurality of pixel units with the voltage controller.

### CROSS-REFERENCE TO RELATED APPLICATIONS

This application is based upon International Application No. PCT/CN2017/074552, filed on Feb. 23, 2017, which is based upon and claims priority of Chinese Patent Application No. 201610371628.1 filed on May 30, 2016, which is hereby incorporated by reference in its entirety as part of this application.

### TECHNICAL FIELD

The embodiments of present disclosure relate to the display technology, and more particularly to a display device and a driving method thereof.

### BACKGROUND

Organic light-emitting diode (OLED) display technology has the characteristics of self-luminous, and an OLED display device has a large viewing angle and can save energy.

The existing OLED display device includes a plurality of pixel units, each of which employs a structure such as a 3T1C. In the prior art, it is necessary to provide a thin film transistor which is directly connected to the OLED for controlling whether or not the OLED in the pixel unit can emit light in each pixel unit. This results in an excessive number of TFTs in the OLED display device, and an increase of structure complexity of a product, thereby reducing an aperture ratio of the pixel unit, increasing power consumption, and increasing the possibility of product failure when manufacturing the product. The transistor is located in the pixel unit, so that it is not easy to maintain the thin film transistor when it is damaged.

It should be noted that, information disclosed in the above background portion is provided only for better understanding of the background of the present disclosure, and thus it may contain information that does not form the prior art known by those skilled in the art.

### SUMMARY

An embodiment of the present disclosure provides a display device and a driving method thereof.

An embodiment of the present disclosure provides a display device, including a timing controller, a switching unit, a voltage controller and a plurality of pixel units arranged sequentially, the timing controller is connected with the switching unit, the voltage controller is connected with the switching unit, and the switching unit is connected with the pixel units;

the timing controller is configured to output a timing control signal for determining whether the switching unit electrically connects the voltage controller with the pixel units;

the switching unit is configured to electrically connect the voltage controller with the pixel units in accordance with the timing control signal, such that a control voltage output from the voltage controller is transmitted to each of the pixel units;

each of the pixel units is configured to display when receiving the control voltage,

wherein the switching unit can electrically connect more than one pixel unit with the voltage controller.

An embodiment of the present disclosure provides a driving method of a display device, wherein the display device includes a timing controller, a switching unit, a voltage controller and a plurality of pixel units arranged sequentially, the timing controller is connected with the switching unit, the voltage controller is connected with the switching unit, and the switching unit is connected with the pixel units,

the driving method comprising:

outputting, by the timing controller, a timing control signal for determining whether the switching unit electrically connects the voltage controller with the pixel units;

electrically connecting, by the switching unit, the voltage controller with the pixel units in accordance with the timing control signal, such that a control voltage output from the voltage controller is transmitted to each of the pixel units;

displaying, by the pixel units, when receiving the control voltage,

wherein in the connecting, by the switching unit, the voltage controller with the pixel units in accordance with the timing control signal, the plurality of pixel units are electrically connected with the voltage controller through one of the switching unit.

It is to be understood that both the foregoing general description and the following detailed description are exemplary and explanatory only and are not restrictive of the present disclosure, as claimed.

This section provides a summary of various implementations or examples of the technology described in the disclosure, and is not a comprehensive disclosure of the full scope or all features of the disclosed technology.

### BRIEF DESCRIPTION OF THE DRAWINGS

FIG. 1 is a schematic diagram of a structure of a pixel unit in the prior art;

FIG. 2 is a schematic diagram of a structure of a display device provided by a first embodiment of the present disclosure;

FIG. 3 is a schematic diagram of a concrete structure of some of the components of the display device in FIG. 2;

FIG. 4 is a schematic diagram of a timing of the display device in FIG. 2 for 3D display;

FIG. 5 is a schematic diagram of a timing of the display device in FIG. 2 for 2D display; and

FIG. 6 is a flow chart of a driving method of a display device provided by a second embodiment of the present disclosure.

### DETAILED DESCRIPTION

The display device and the driving method thereof provided in the embodiments of the present disclosure will be described in detail with reference to the accompanying drawings in order to provide a better understanding of technical solutions of the embodiments of the present invention for those skilled in the art.

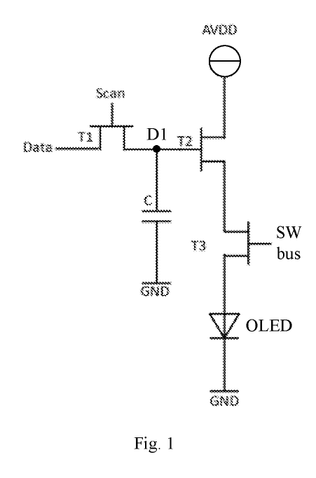

FIG. 1 is a schematic diagram of a pixel unit having a 3T1C structure in the prior art. As shown in FIG. 1, the pixel unit includes a thin film transistor T1, a thin film transistor T2, a thin film transistor T3, a capacitor C and an OLED. Thin film transistor T1 has a control electrode connected to a gate line Scan, a first electrode connected to a data line Data, and a second electrode connected to a node D1. The thin film transistor T2 has a control electrode connected to the node D1, a first electrode connected to a driving power supply AVDD, and a second electrode connected to a first electrode of the thin film transistor T3. The thin film transistor T3 has a control electrode connected to a SW bus, a second electrode connected to a first electrode of the OLED. The OLED has a second electrode which is grounded. The capacitor C has a first end connected to the node D1 and a second electrode which is grounded. In an OELD display device, the control electrode of the thin film transistor T3 of each of the plurality of pixel units is connected to the SW bus. During a display period (T2), the SW bus outputs a signal having a high level to the control electrode of the thin film transistor T3 of each pixel unit, such that all of the thin film transistors T3 of the plurality of pixel units are turned on, and the OLED emits light, thereby achieving the light emission of the OLED. During a data scanning period, the SW bus outputs a signal having a low level to the control electrode of the thin film transistor T3 of each pixel unit, such that all of the thin film transistors T3 are turned off. Thus there is no crosstalk between left and right eyes for the 3D display.

However, in the existing structure shown in FIG. 1, each pixel unit needs to be provided with a thin film transistor T3 that controls whether the OLED in the pixel unit can emit light, which results in an excessive number of TFTs in the OLED display device and an increase of structure complexity of a product, thereby reducing an aperture ratio of the pixel unit, increasing power consumption, and increasing the possibility of product failure when manufacturing the product. Since the thin film transistor T3 is located in the pixel unit, when the thin film transistor T3 cannot be repaired and replaced when it is damaged.

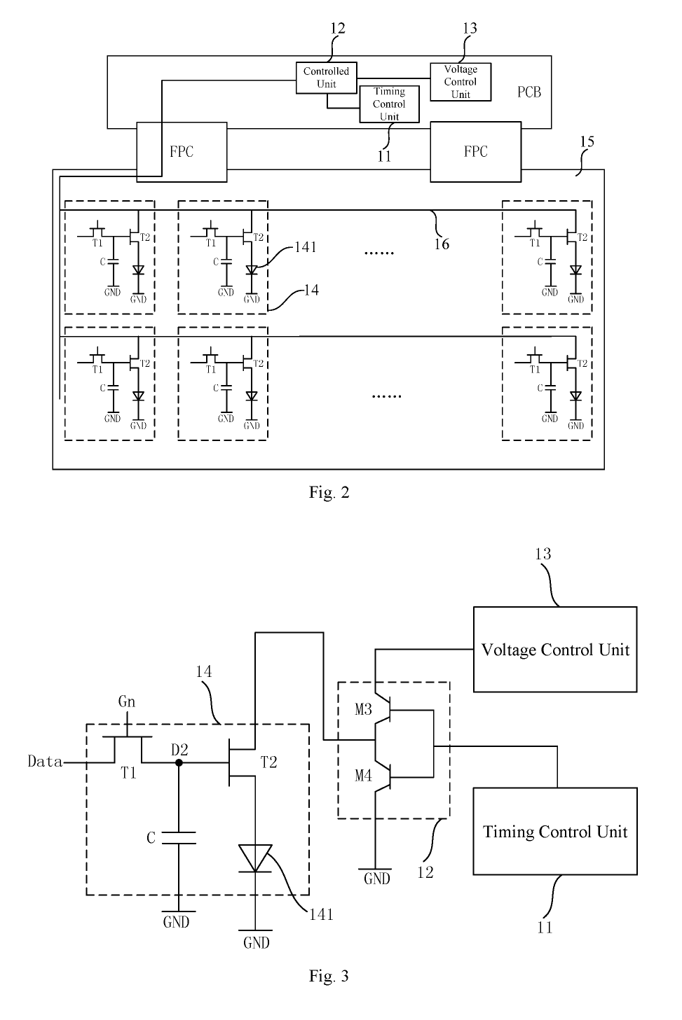

FIG. 2 is a schematic diagram of a structure of a display device provided by a first embodiment of the present disclosure, and FIG. 3 is a schematic diagram of a concrete structure of some of the components of the display device in FIG. 2. As shown in FIGS. 2 and 3, the display device includes a timing controller 11, a switching unit 12, a voltage controller 13 and a plurality of pixel units 14 arranged sequentially. The timing controller 11 is connected with the switching unit 12, the voltage controller 13 is connected with the switching unit 12, and the switching unit 12 is connected with each of the plurality of pixel units 14.

The timing controller 11 is configured to output a timing control signal for determining whether the switching unit 12 electrically connects the voltage controller 13 with the pixel units 14. The switching unit 12 is configured to electrically connect the voltage controller 13 with the pixel units 14 in accordance with the timing control signal output from the timing controller 11, such that a control voltage output from the voltage controller 13 is transmitted to each of the pixel units 14. The pixel unit 14 is configured to display when receiving the control voltage.

In this embodiment, one switching unit 12 can electrically connect the plurality of pixel units 14 with the voltage controller 13. In other words, under the control of the timing control signal, a plurality of pixel units 14 are electrically connected with the voltage controller 13 through one switching unit 12. For example, as shown in FIG. 2, all of the pixel units 14 are connected with the voltage controller through one switching unit 12. Of course, the present disclosure is not limited thereto, provided that it ensures that one switching unit 12 is capable of electrically connecting more than one pixel unit 14 with the voltage controller 13.

In this embodiment, the voltage controller 13 may be a power management (PM) chip.

It is to be noted that a gate line and a data line are not specifically drawn in FIG. 2.

For simplicity, the scheme of the present embodiment will be described with reference to the case where the switching unit 12 is connected to one pixel unit 14 in FIG. 3. As shown in FIG. 3, the pixel unit 14 includes a first switching transistor T1, a second switching transistor T2, a capacitor C and a light emitting device 141. The first switching transistor T1 has a control electrode connected with a gate line Gn, a first electrode connected with a data line Data, and a second electrode connected to a node D2. The second switching transistor T2 has a control electrode connected to the node D2, a first electrode connected with the switching unit 12, a second electrode connected with a first electrode of the light emitting device 141. The capacitor C has a first end connected to the node D2 and a second end connected to a reference power supply. The light emitting device 141 has a second electrode connected to the reference power supply. In the example shown in FIG. 3, the light emitting device 141 is an OLED, and the reference power supply is a ground terminal GND, in this case, the second end of the capacitor C is grounded, and the second electrode of the light emitting device 141 is grounded.

In this embodiment, the switching unit 12 includes a third switching transistor M3 and a fourth switching transistor M4. The third switching transistor M3 has a control electrode connected with the timing controller 11, a first electrode connected with the voltage controller 13, and a second electrode connected with a first electrode of the fourth switching transistor M4. The fourth switching transistor M4 has a control electrode connected with the timing controller 11, a second electrode connected to the reference power supply. In the example shown in FIG. 3, the reference power supply is a ground terminal GND, in this case, the second electrode of the fourth switching transistor M4 is grounded. In this embodiment, the timing controller 11 enables switching control of the third switching transistor M3 and the fourth switching transistor M4 via the general purpose input output (GPIO) interface.

As shown in FIG. 2, in this embodiment, the timing controller 11, the switching unit 12 and the voltage controller 13 are located on a printed circuit board (PCB), the plurality of pixel units 14 are located in a display panel 15, and the printed circuit board PCB is connected with the display panel 15 through the flexible circuit board (FPC). The display panel 15 includes a plurality of interconnected connection buses 16, and each connection bus 16 is connected with a plurality of pixel units 14. In particular, each connection bus 16 may be connected with all the pixel units 14 in one row. The switching unit 12 is connected with each connection bus 16 through the flexible circuit board FPC.

The display device in the present embodiment may be used for the 2D display mode or the 3D display mode.

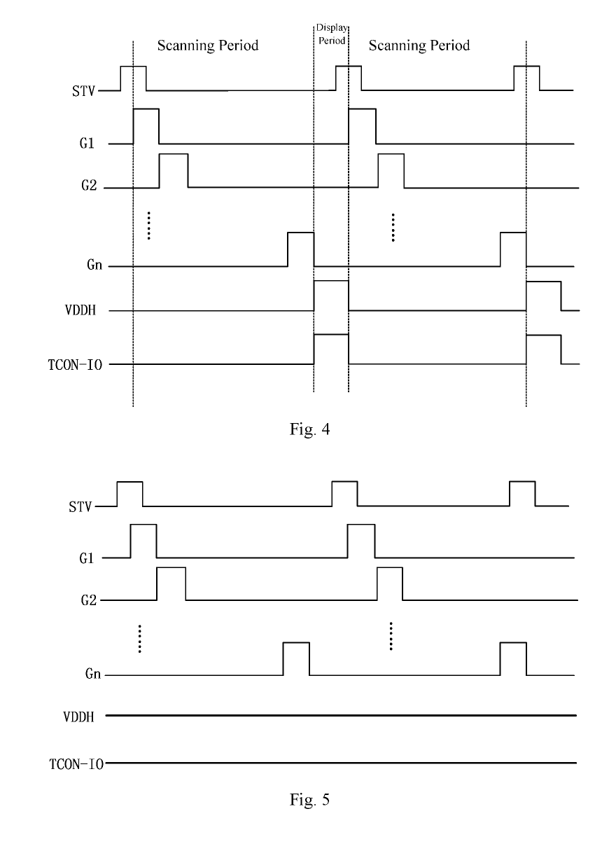

FIG. 4 is a schematic diagram of a timing of the display device in FIG. 2 for 3D display. As shown in FIGS. 2, 3 and 4, the display of a picture of one frame is started under the control of a start vertical (STV) signal. During a scanning period (T1), when a picture of one frame is displayed, gate lines G1 to Gn are scanned line by line. Take the gate line Gn as an example, the gate line Gn outputs a gate control signal to the first switching transistor T1, and the first switching transistor T1 is turned on when the gate control signal has a high level. The data line Data charges the node D2 through the first switching transistor T1 which is turned on, thereby achieving the charging of the capacitor C. The voltage at the control electrode of the second switching transistor T2 is the voltage at the node D. During the scanning of the gate lines G1 to Gn line by line, the timing controller 11 outputs a timing control voltage TCON-IO to the control electrode of the third switching transistor M3 and the control electrode of the fourth switching transistor M4. The third switching transistor M3 is turned off under the control of the timing control voltage TCON-IO, and the fourth switching transistor M4 is turned on under the control of the timing control voltage TCON-IO, such that the voltage controller 13 and each pixel unit 14 are turned off. In this embodiment, the third switching transistor M3 is a P-type metal-oxide semiconductor field effect transistor (MOSFET), the fourth switching transistor M4 is an N-type MOSFET, and the timing control voltage TCON-IO is a voltage having a high level. In this case, the third switching transistor M3 is turned off under the control of the voltage having a high level, and the fourth switching transistor M4 is turned on under the control of the voltage having a high level. Since the third switching transistor M3 is turned off, each pixel unit 14 is disconnected from the voltage controller 13, and the voltage controller 13 cannot output a control voltage VDDH to the second switching transistor T2 of the pixel unit 14 through the third switching transistor M3. Also, since the fourth switching transistor M4 is turned on, the first electrode of the second switching transistor T2 is grounded through the fourth switching transistor M4. Thus the second switching transistor T2 is turned off, such that the pixel unit 14 does not perform a display. When the control voltage VDDH is a voltage having a low level, the effect of energy saving can be achieved. Optionally, in a practical application, when the third switching transistor M3 is an N-type MOSFET, and the fourth switching transistor is a P-type MOSFET, the timing control voltage is a voltage having a low level. In this case, the third switching transistor M3 is turned off under the control of the voltage having the low level, and the fourth switching transistor M4 is turned on under the control of the voltage having the low level, which are not specifically shown.

During the display period of displaying the picture of such frame, the timing controller 11 outputs a timing control voltage TCON-IO having a high level to the control electrode of the third switching transistor M3 and the control electrode of the fourth switching transistor M4. The third switching transistor M3 is turned on under the control of the timing control voltage TCON-IO, and the fourth switching transistor M4 is turned off under the control of the timing control voltage TCON-IO, such that the voltage controller 13 is connected to each pixel unit 14. In this embodiment, the third switching transistor M3 is a P-type MOSFET, the fourth switching transistor M4 is an N-type MOSFET, and the timing control voltage TCON-IO is a voltage having a low level during the display period. In this case, the third switching transistor M3 is turned on under the control of the voltage having the low level, and the fourth switching transistor M4 is turned off under the control of the voltage having the low level. Since the third switching transistor M3 is turned on, each pixel unit 14 is electrically connected with the voltage controller 13. The voltage controller 13 outputs the control voltage VDDH simultaneously to the second switching transistor T2 of each pixel unit 14 through the third switching transistor M3 which is turned on, and the second switching transistor T2 drives the light emitting device 141 to emit light, such that the pixel unit 14 performs a display. At this time, the control voltage VDDH is a voltage having a high level. Optionally, in a practical application, when the third switching transistor M3 is an N-type MOSFET, and the fourth switching transistor is a P-type MOSFET, the timing control voltage is a voltage having a high level during a display period. In this case, the third switching transistor M3 is turned on under the control of the voltage having the high level, and the fourth switching transistor M4 is turned off under the control of the voltage having the high level, which are not specifically shown.

Further, the above process is repeated for the display of the next frame. One frame in the continuous frames is a left-eye picture, and the other frame is a right-eye picture. In a display period of a 3D display mode, the switching unit 12 may transmit the control voltage output from the voltage controller 13 to each pixel unit 14 when the voltage controller 13 and the pixel unit 14 are electrically connected with each other, thereby turning on each pixel unit simultaneously. In a scanning period of a 3D display mode, the switching unit 12 disconnects the voltage controller 13 from the pixel unit 14 under the control of the timing controller 11, and does not transmit the control voltage output from the voltage controller 13 to the pixel unit 14, thereby turning off each pixel unit 14 simultaneously. As shown in FIG. 4, the display periods of the pictures of the adjacent two frames are displayed for the left and right eyes respectively, and the two display periods are separated by the scanning period between them. Thus the purpose of separating the picture for the left eye and the picture for the right eye can achieved, such that the 3D display without crosstalk is achieved.

FIG. 5 is a schematic diagram of a timing of the display device in FIG. 2 for 2D display. As shown in FIGS. 2, 3 and 5, the display of a picture of one frame is started under the control of a STV signal. When a picture of one frame is displayed, gate lines G1 to Gn are scanned line by line. Take the gate line Gn as an example, the gate line Gn outputs a gate control signal to the first switching transistor T1, and the first switching transistor T1 is turned on when the gate control signal has a high level. The data line Data charges the node D2 through the first switching transistor T1 which is turned on, thereby achieving the charging of the capacitor C. The voltage at the control electrode of the second switching transistor T2 is the voltage at the node D. The timing controller 11 outputs a timing control voltage TCON-IO to the control electrode of the third switching transistor M3 and the control electrode of the fourth switching transistor M4. The third switching transistor M3 is turned on under the control of the timing control voltage TCON-IO, and the fourth switching transistor M4 is turned off under the control of the timing control voltage TCON-IO, such that the voltage controller 13 and the pixel unit 14 are electrically connected with each other. In this embodiment, the third switching transistor M3 is a P-type MOSFET, the fourth switching transistor M4 is an N-type MOSFET, and the timing control voltage TCON-IO is a voltage having a low level. In this case, the third switching transistor M3 is turned on under the control of the voltage having the low level, and the fourth switching transistor M4 is turned off under the control of the voltage having the low level. The voltage controller 13 outputs the control voltage VDDH simultaneously to the second switching transistor T2 of each pixel unit 14 through the third switching transistor M3 which is turned on, and the second switching transistor T2 drives the light emitting device 141 to emit light, such that the pixel unit 14 performs a display. At this time, the control voltage VDDH is a voltage having a high level. Further, the above process is repeated for the display of the next frame. As shown in FIG. 5, in a 2D display mode, the control voltage VDDH is always a voltage having a high level, and the timing control voltage TCON-IO is always a voltage having a high level.

In the technical scheme of the display device provided by the present embodiment, the display device includes a timing controller, a switching unit, a voltage controller and a plurality of pixel units. The switching unit is configured to electrically connect the voltage controller with the pixel units in accordance with a timing control signal output from the timing controller, such that a control voltage output from the voltage controller is transmitted to each pixel unit. In this embodiment, the switching unit for controlling the display of the pixel units are disposed outside of the pixel units, and one switching unit can control a plurality of pixel units without disposing the switching unit inside each pixel unit, such that the number of the switching units of the display device is small, and the complexity of the product structure is reduced, thereby increasing the aperture ratio of the pixel unit, reducing power consumption, and improving product yield. Since the switching unit is located outside of the pixel unit, it is easy to repair the switching unit when it is damaged, thus improving the maintainability. In this embodiment, there are only two switching transistors in the pixel unit, compared with the existing technology, one switching transistor is reduced from each pixel unit, thereby further increasing the aperture ratio of the pixel unit, reducing power consumption, and improving product yield.

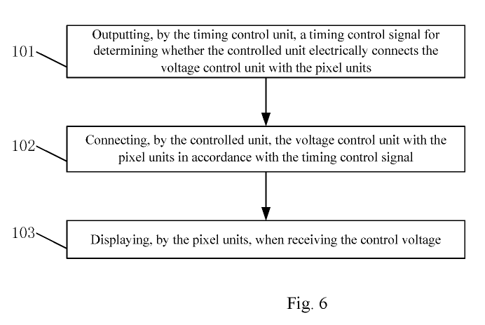

FIG. 6 is a flow chart of a driving method of a display device provided by a second embodiment of the present disclosure. As shown in FIG. 6, the display device includes a timing controller, a switching unit, a voltage controller and a plurality of pixel units arranged sequentially. The timing controller is connected with the switching unit, the voltage controller is connected with the switching unit, and the switching unit is connected with each of the pixel units.

The method includes the following steps 101-103.

At step 101, a timing control signal for determining whether the switching unit electrically connects the voltage controller with the pixel units is output by the timing controller.

In this embodiment, the switching unit includes a third switching transistor and a fourth switching transistor. The third switching transistor has a control electrode connected with the timing controller, a first electrode connected with the voltage controller, and a second electrode connected with a first electrode of the fourth switching transistor. The fourth switching transistor has a control electrode connected with the timing controller, and a second electrode connected to a reference power supply.

The step 101 particularly includes:

during a scanning period, outputting, by the timing controller, a timing control voltage having a first level to the control electrode of the third switching transistor and the control electrode of the fourth switching transistor, such that the third switching transistor is turned off and the fourth switching transistor is turned on, thereby disconnecting the voltage controller from each of the pixel units; or

during a display period, outputting, by the timing controller, a timing control voltage having a second level to the control electrode of the third switching transistor and the control electrode of the fourth switching transistor, such that the third switching transistor is turned on and the fourth switching transistor is turned off, thereby electrically connecting the voltage controller with each of the pixel units.

At step 102, the voltage controller is electrically connected with the pixel units by the switching unit in accordance with the timing control signal, such that a control voltage output from the voltage controller is transmitted to each of the pixel units, wherein the plurality of pixel units are electrically connected with the voltage controller via one of the switching unit.

At step 103, a display is performed by the pixel units when the control voltage is received.

The driving method of the display device provided by the present embodiment may be used to drive the display device provided by the first embodiment described as above, and the description of the display device may be found in the first embodiment described as above, which will not be described here.

In the technical scheme of the display device provided by the present embodiment, the display device includes a timing controller, a switching unit, a voltage controller and a plurality of pixel units. The switching unit is configured to electrically connect the voltage controller with the pixel units in accordance with a timing control signal output from the timing controller, such that a control voltage output from the voltage controller is transmitted to each pixel unit. In this embodiment, the switching unit for controlling the display of the pixel units are disposed outside of the pixel units, and one switching unit can control a plurality of pixel units without disposing the switching unit inside each pixel unit, such that the number of the switching units of the display device is small, and the complexity of the product structure is reduced, thereby increasing the aperture ratio of the pixel unit, reducing power consumption, and improving product yield. Since the switching unit is located outside of the pixel unit, it is easy to repair the switching unit when it is damaged, thus improving the maintainability.

It is to be understood that the above embodiments are merely exemplary embodiments for the purpose of illustrating the principles of the present disclosure, but the present disclosure is not limited thereto. It will be apparent to those skilled in the art that various changes and modifications can be made therein without departing from the spirit and spirit of the present disclosure, which are also considered to be within the scope of the present disclosure.

1. A display device, comprising a timing controller, a switching unit, a voltage controller and a plurality of pixel units arranged sequentially,
wherein the timing controller is connected with the switching unit, the voltage controller is connected with the switching unit, and the switching unit is connected with the pixel units,
the timing controller is configured to output a timing control signal for determining whether the switching unit electrically connects the voltage controller with the pixel units;
the switching unit is configured to electrically connect the voltage controller with the pixel units in accordance with the timing control signal, such that a control voltage output from the voltage controller is transmitted to each of the pixel units;
each of the pixel units is configured to display when receiving the control voltage,
wherein the switching unit can electrically connect more than one pixel units with the voltage controller.

2. The display device of claim 1, wherein each of the plurality of pixel units comprises a first switching transistor, a second switching transistor, a capacitor and a light emitting device,
the first switching transistor has a control electrode connected with a gate line, a first electrode connected with a data line, and a second electrode connected with a control electrode of the second switching transistor,
the second switching transistor has a first electrode connected with the switching unit and a second electrode connected with a first electrode of the light emitting device,
the capacitor has a first end connected with the second electrode of the first switching transistor and a second end connected with a reference power supply, and
the light emitting device has a second electrode connected to the reference power supply.

3. The display device of claim 1, wherein the switching unit comprises a third switching transistor and a fourth switching transistor,
the third switching transistor has a control electrode connected with an output end of the timing controller, a first electrode connected with an output end of the voltage controller, and a second electrode connected with a first electrode of the fourth switching transistor,
the fourth switching transistor has a control electrode connected with the output end of the timing controller, and a second electrode connected to the reference power supply.

4. The display device of claim 3, wherein the timing controller outputs a timing control voltage to the control electrode of the third switching transistor and the control electrode of the fourth switching transistor, when the timing control voltage has a first level, the third switching transistor is turned off and the fourth switching transistor is turned on, such that the voltage controller is disconnected from each of the pixel units; and when the timing control voltage has a second level different from the first level, the third switching transistor is turned on and the fourth switching transistor is turned off, such that the voltage controller is electrically connected with each of the pixel units.

5. The display device of claim 4, wherein the third switching transistor is a P-type metal-oxide semiconductor field effect transistor, the fourth switching transistor is an N-type metal-oxide semiconductor field effect transistor, the first level is a high level, and the second level is a low level; or
the third switching transistor is an N-type metal-oxide semiconductor field effect transistor, the fourth switching transistor is a P-type metal-oxide semiconductor field effect transistor, the first level is a low level, and the second level is a high level.

6. The display device of claim 1, wherein the timing controller, the switching unit and the voltage controller are located on a printed circuit board, the plurality of pixel units are located in a display panel, and the printed circuit board is connected with the display panel through a flexible circuit board,
the display panel comprises a plurality of interconnected connection buses, each of which is connected with a plurality of pixel units,
the switching unit is connected with each of the connection buses through the flexible circuit board.

7. A driving method of a display device, wherein the display device comprises a timing controller, a switching unit, a voltage controller and a plurality of pixel units arranged sequentially, the timing controller is connected with the switching unit, the voltage controller is connected with the switching unit, and the switching unit is connected with the pixel units,
the driving method comprising:
outputting, by the timing controller, a timing control signal for determining whether the switching unit electrically connects the voltage controller with the pixel units;
electrically connecting, by the switching unit, the voltage controller with the pixel units in accordance with the timing control signal, such that a control voltage output from the voltage controller is transmitted to each of the pixel units;
displaying, by the pixel units, when receiving the control voltage,
the connecting, by the switching unit, the voltage controller with the pixel units in accordance with the timing control signal, more than one pixel units are electrically connected with the voltage controller through the switching unit.

8. The driving method of claim 7, wherein the switching unit comprises a third switching transistor and a fourth switching transistor, the third switching transistor has a control electrode connected with the timing controller, a first electrode connected with the voltage controller, and a second electrode connected with a first electrode of the fourth switching transistor, the fourth switching transistor has a control electrode connected with the timing controller and a second electrode connected to a reference power supply,
the outputting, by the timing controller, the timing control signal for determining whether the switching unit electrically connects the voltage controller with the pixel units comprises:
during a scanning period, outputting, by the timing controller, a timing control voltage having a first level to the control electrode of the third switching transistor and the control electrode of the fourth switching transistor, such that the third switching transistor is turned off and the fourth switching transistor is turned on, thereby disconnecting the voltage controller from each of the pixel units; or
during a display period, outputting, by the timing controller, a timing control voltage having a second level to the control electrode of the third switching transistor and the control electrode of the fourth switching transistor, such that the third switching transistor is turned on and the fourth switching transistor is turned off, thereby electrically connecting the voltage controller with each of the pixel units.
